(19) United States
(12) Patent Application Publication
(10) Pub. No.: US 2014/0148141 A1
(43) Pub. Date: May 29, 2014

(54) SYSTEM, APPARATUS AND METHOD FOR CONTROLLING TRANSMISSION OF SELECTED COMMUNICATIONS TO A MOBILE COMMUNICATION DEVICE CARRIED BY A VEHICLE

(71) Applicant: WEST CORPORATION, Omaha, NE (US)

(72) Inventor: John Lawrence Snapp, Westminster, CO (US)

(73) Assignee: WEST CORPORATION, Omaha, NE (US)

(21) Appl. No.: 13/798,412

(22) Filed: Mar. 13, 2013

Related U.S. Application Data
(60) Provisional application No. 61/730,320, filed on Nov. 27, 2012.

(51) Int. Cl. H04W 4/04

(52) U.S. Cl. CPC H04W 4/046
USPC 455/418

(57) ABSTRACT

A system for use with a vehicle to control transmission of communications to a traveling mobile communication device in the vehicle includes: (a) a vehicle activity monitoring unit coupled with a self diagnostic device installed on the vehicle; and (b) a server unit coupled for controlling communications with served mobile units coupled with a mobile network that includes a plurality of elements configured for effecting selected types of communications with the served mobile units. The vehicle activity monitoring unit is communicatingly coupled with the server via the mobile network. The server unit cooperates with the activity monitoring unit to identify which served mobile communication unit is a traveling mobile communication device. The server unit cooperates with particular elements of the mobile network to control particular types of communications with the traveling mobile communication device when the vehicle activity monitoring unit indicates the vehicle is engaged in a predetermined activity.

### CROSS-REFERENCE TO RELATED APPLICATIONS

This application is a continuation from U.S. Provisional Patent Application Ser. No. 61/730,320, filed Nov. 27, 2012, and entitled “SYSTEM, APPARATUS AND METHOD FOR CONTROLLING TRANSMISSION OF SELECTED COMMUNICATIONS TO A MOBILE COMMUNICATION DEVICE CARRIED BY A VEHICLE”, which is incorporated by reference herein in its entirety.

### FIELD OF THE INVENTION

The present invention is directed to telecommunication systems, and especially to limiting or otherwise controlling calls made to mobile devices traveling with a vehicle.

### BACKGROUND OF THE INVENTION

For purposes of this disclosure, operation of a mobile device while being carried in a moving vehicle will be referred to as “texting while driving”. This terminology is intended to include operation of a mobile device for texting as well as for other operations to include, by way of example and not by way of limitation, MMS (Multimedia Messaging Service) messaging and other operation of mobile device while a passenger in a moving vehicle. Voice communication may be included as well within the meaning of “texting while driving”.

It is known that using a mobile device such as, by way of example and not by way of limitation, a mobile phone, gaming unit or similar device may be a distraction for an operator of a vehicle. In particular, it is known that texting while driving is a dangerous practice that has contributed to several traffic incidents resulting in injury or death.

Some manufacturers have proposed altering a mobile device to enable the device to sense when it is experiencing motion similar to motion by a vehicle. The altered mobile device may respond to such motion sensing by limiting communication capabilities of the mobile device such as by prohibiting texting operation by the mobile device.

Adding such a sensing and additional control capability to a mobile device may add to the cost and complexity of the device. An increase in cost may cause buyers to seek to purchase less expensive devices not having such a sensing and control capability in order to save money. An increase in complexity may render the device more prone to failure. Benefits that may be realized by such an individual-device solution to the problem of texting while driving may be diminished by buyers exercising an economic choice in purchasing alternate mobile devices not having a sensing and additional control capability.

It would be useful to provide a motion sensing and operational control capability on a system level. A system-level approach may spread the cost of installing a capability to limit texting while driving over a large number of users and may make use of the capability more universal than may be accomplished using an individual-phone approach. A system-level approach may permit accomplishing the control of transmission of selected communications to mobile communication devices without requiring any change to the mobile communication devices. A system-level approach may therefore avoid additional costs or increased likelihood of breakdown that may be introduced using an individual-phone approach.

There is a need for a system-level system, apparatus and method for controlling transmission of selected communications to a mobile communication device carried by a vehicle.

### SUMMARY OF THE INVENTION

A system for use with a vehicle having an installed self diagnostic device; the system controlling transmission of selected communications to at least one traveling mobile communication device carried by the vehicle includes: (a) a vehicle activity monitoring unit coupled with the self diagnostic device; and (b) a server unit coupled for controlling communications with served mobile communication units communicatingly coupled with a mobile communication network. The mobile communication network includes a plurality of elements configured for effecting selected types of communications with the served mobile communication units. The vehicle activity monitoring unit is communicatingly coupled with the server via the mobile communication network. The server unit cooperates with the activity monitoring unit to identify which of the served mobile communication units are the at least one traveling mobile communication device. The server unit cooperates with particular elements of the plurality of elements of the mobile communication network to control particular types of communications of the selected types of communications with the at least one traveling mobile communication device when the vehicle activity monitoring unit indicates the vehicle is engaged in a predetermined activity.

An apparatus for use with a vehicle having an installed self diagnostic device includes: (a) a controller unit coupled with the self diagnostic device; the controller unit receives information from the self diagnostic device regarding operating parameters of the vehicle; the controller unit substantially controls operation of the apparatus; and (b) a mobile communicating unit coupled with the controller unit. The mobile communicating unit is configured for communicating the operating parameters from the apparatus via a mobile communicating network.

A method for controlling transmission of selected communications to at least one traveling mobile communication device carried by a vehicle having an installed self diagnostic device includes: (a) coupling a vehicle activity monitoring unit with the self diagnostic device; (b) providing a server unit coupled with a mobile communication network and communicatingly coupled with the vehicle activity monitoring unit; the mobile communication network including a plurality of elements configured for effecting selected types of communications with served mobile communication units; (c) cooperatively operating the server unit with the activity monitoring unit to identify which of the served mobile communication units are the at least one traveling mobile communication device; (d) operating the server unit cooperatively with particular elements of the plurality of elements of the mobile communication network to control particular types of communications of the selected types of communications with the at least one traveling mobile communication device when the vehicle activity monitoring unit indicates the vehicle is engaged in a predetermined activity; and (e) terminating the method when the vehicle activity monitoring unit indicates the vehicle is no longer engaged in a predetermined activity

It is, therefore, a feature of the present invention to provide a system-level system, apparatus and method for controlling transmission of selected communications to a mobile communication device carried by a vehicle.

Further features of the present invention will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

FIG. 1 is a schematic illustration of a system and apparatus for effecting the present invention.

FIG. 2 is a schematic diagram illustrating various ways that the provisioning unit illustrated in FIG. 1 may be updated.

FIG. 3 is a schematic diagram illustrating a first representative embodiment for coupling the apparatus of the invention with an installed self diagnostic device.

FIG. 4 is a schematic diagram illustrating a second representative embodiment for coupling the apparatus of the invention with an installed self diagnostic device.

FIG. 5 is a schematic diagram illustrating a third representative embodiment for coupling the apparatus of the invention with an installed self diagnostic device.

FIG. 6 is a flow diagram illustrating operation of the present invention.

FIG. 7 is a flow diagram illustrating a first representation of the method of the present invention.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

When the terms “coupled” and “connected”, along with their derivatives, are used herein, it should be understood that these terms are not intended as synonyms for each other. Rather, in particular embodiments, “connected” is used to indicate that two or more elements are in direct physical or electrical contact with each other. “Coupled” is used to indicated that two or more elements are in either direct or indirect (with other intervening elements between them) physical or electrical contact with each other, or that the two or more elements co-operate or interact with each other (e.g., as in a cause-and-effect relationship).

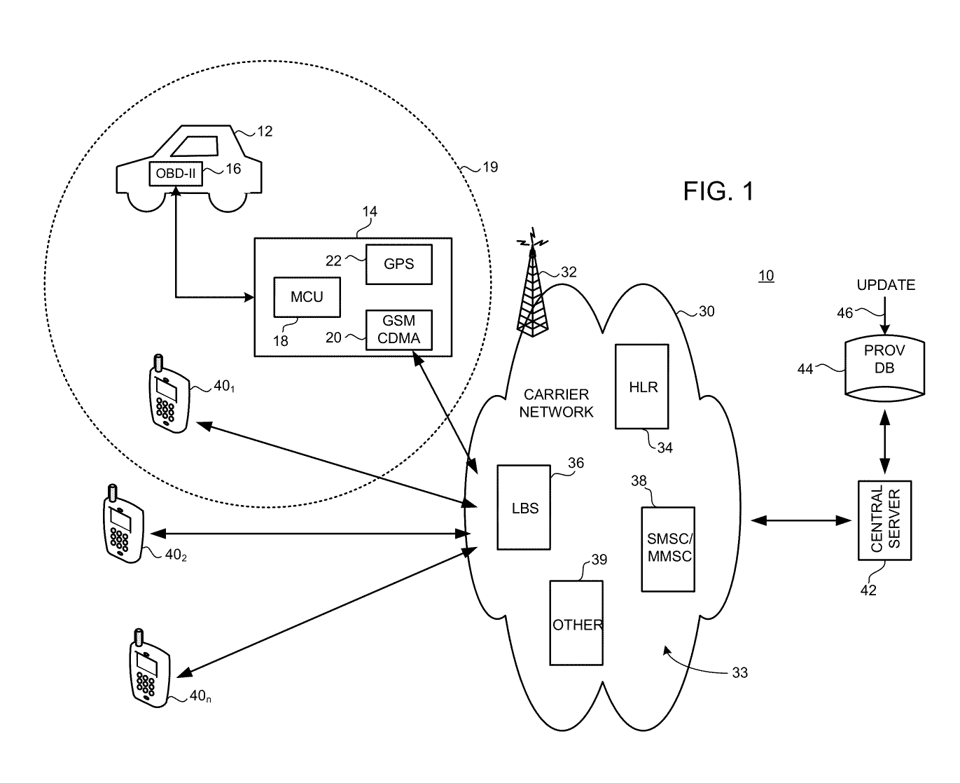

FIG. 1 is a schematic illustration of a system and apparatus for effecting the present invention. In FIG. 1, a system 10 for controlling communications with a vehicle 12 includes an apparatus 14, a mobile communication network 30 and a server unit 42. Apparatus 14 may be coupled with a self-diagnostic device 16 installed in vehicle 12. For purposes of illustration only, vehicle 12 is represented as an automobile. Vehicle 12 may be embodied in any vehicle including, without limitation, a truck, a boat, an aircraft or another vehicle. For purposes of illustration only, self-diagnostic device 16 is represented as an On Board Diagnostic device employing the OBD-II standard known in the art. The present invention is not limited to employment with the OBD-II standard and can be employed with any standard relating to self-diagnostic devices used with vehicles.

For purposes of this disclosure, On Board Diagnostics (OBD) is an automotive term referring to a vehicle's self-diagnostic and reporting capability. OBD systems are generally configured to provide a vehicle owner or repair technician access to information relating to the state of health for various vehicle sub-systems. Modern OBD implementations may use a standardized digital communications port to provide real-time data in addition to a standardized series of Diagnostic Trouble Codes (DTC) which allow one to rapidly identify and remedy malfunctions within the vehicle.

The OBD-II standard specifies the type of diagnostic connector and its pinout, the electrical signaling protocols available, and the messaging format. The standard also provides a candidate list of vehicle parameters to monitor along with how to encode the data for each. There is a pin in the connector that provides power for the scan tool from the vehicle battery, which eliminates the need to connect a scan tool to a power source separately. However, some technicians might still connect the scan tool to an auxiliary power source to protect data in the unusual event that a vehicle experiences a loss of electrical power due to a malfunction. The OBD-II standard provides an extensible list of DTCs. As a result of this standardization, a single reader device can query the on-board computer(s) in any vehicle.

Apparatus 14 includes a controller unit 18 and a mobile communicating unit 20. Controller unit 18 is representatively indicated as a Microcontroller Unit (MCU), but may be embodied in any appropriate control unit as that term may be understood in the art of digital circuitry. Mobile communicating unit 20 may be, by way of example and not by way of limitation, a cellular phone module and is representatively indicated as employing GSM (Group Speciale Mobile; or Global System for Mobile communications) communication technology or Code Division Multiple Access (CDMA) communication technology. However, mobile communicating unit 20 may employ any communication technology with the present invention.

Dotted-line circle 19 indicates which elements of system 10 travel with vehicle 12. Apparatus 14 is coupled with self-diagnostic unit 16 and travels with vehicle 12 and self-diagnostic device 16. Apparatus 14 may include a Global Positioning System (GSM) unit 22 for ascertaining the geographic location of apparatus 14. Apparatus 14 may be configured to sense parameters associated with motion including, by way of example and not by way of limitation, velocity, acceleration (in up to three axes), rate of acceleration, turning maneuvers, rate of turning maneuvers and other motion-related parameters.

Apparatus 14 may be an electronic module that may be coupled with vehicle 12 via an existing OBD-II connector under the dash of vehicle 12. Apparatus 14 may have its own power source, such as a battery (not shown in FIG. 1). Preferably apparatus 14 will draw power and vehicle information though a standard OBD-II interface or other appropriate interface. Apparatus 14 may also obtain location information through GPS unit 22. Apparatus 14 may obtain acceleration data through a three-axis accelerometer (not shown in FIG. 1; may be included within MCU 18, mobile communicating unit 20 or elsewhere in apparatus 14). All sensed data may be sent to server unit 42 by mobile communicating unit 20.

Apparatus 14 may also have alarms and be configured to notify server unit 42 whether apparatus 14 is disconnected or has other troubles. Apparatus 14 may be able to detect through the ODB-II connection that apparatus 14 is in a different vehicle than an intended vehicle.

Server unit 42 may be located at a carrier (e.g., within mobile communication network 30) or with a hosting provider (not shown in FIG. 1; understood by those skilled in the art of mobile communication network design). Server unit 42 will preferably cooperate with a provisioning unit 44 to contain all subscriber provisioned information. Server unit 42 may coordinate, via mobile communication network 30, the collection of data from apparatus 14, querying of the traveling mobile devices, notifying appropriate users as directed (e.g., using provisioned information), and commanding appropriate elements 33 of mobile communication network 30 to block and unblock specific services.

Apparatus 14 may, in an alternate embodiment, be configured as an Other Equipment Manufacturer (OEM) telematics device for vehicle 12. In such an alternate embodiment, the OEM telematics device may send substantially the same data to server unit 42 as is described above in describing apparatus 14, and server unit 42 may query the OEM telematics device in substantially the same way as described above. Such an alternate embodiment avoids installing a special device in vehicle 12 such as apparatus 14 and instead substantially incorporates apparatus 14 in the OEM telematics device.

Mobile communication network 30 for effects mobile communications with a plurality of served mobile communication units 40₁, 40₂, 40ₙ. The indicator “n” is employed to signify that there can be any number of served mobile communication units in system 10. The inclusion of three served mobile communication units 40₁, 40₂, 40ₙ in FIG. 1 is illustrative only and does not constitute any limitation regarding the number of served mobile communication units that may be included in the system of the present invention. Throughout this description, use of a reference numeral using a generic subscript herein may be taken to mean that any respective member of the plurality of elements having the same reference numeral may be regarded as included in the description. Thus, by way of example and not by way of limitation, referring to served mobile communication unit 40ₙ in describing FIG. 1 may be taken to mean that any served mobile communication unit—40₁, 40₂, or 40ₙ (FIG. 1)—may be regarded as capable of employment as described.

Mobile communication network 30 may preferably be configured as generally known in the art of mobile communications to include a communication tower 32 and a plurality of elements 33 configured for effecting selected types of communications with served mobile communication units 40ₙ. Plurality of elements 33 may include, by way of example and not by way of limitation, a Home Location Register (HLR) unit 34, a Location Based Services (LBS) unit 36, a Short Message Service Center/Multimedia Message Service Center (SMSC/MMSC) 38 and other elements, represented by a block 39.

Server unit 42 is coupled with mobile communication network 30. A provisioning unit 44, representatively embodied in a provisioning database, is coupled with server unit 42. An update port 46 is provided for providing updated information to provisioning unit 44.

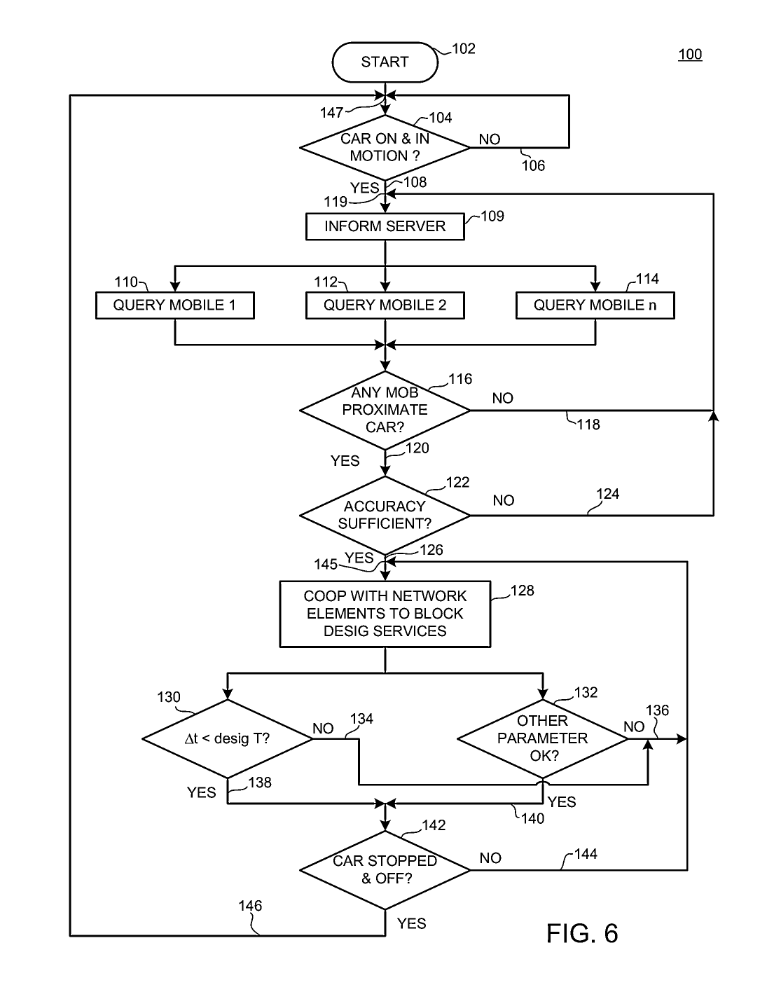

In operation, apparatus 14 cooperates with self-diagnostic device 16 to determine when vehicle 12 has been started and when vehicle 12 is moving. See FIG. 6 for a flow chart illustration of operation of the present invention. Apparatus 14 transmits this information, along with the GPS-based location coordinates (coordinates may be expressed in XY format, GPS coordinate format, or in another location-defining format) and other information relating vehicle 12 to server unit 42. Upon receipt of information indicating that vehicle 12 is a moving vehicle, server unit 42 will query the GPS-based location or cell location of the served mobile communication units 40—that may have been associated with the vehicle (e.g., via update information provided to provisioning unit 44) to determine whether they are in close proximity to the target vehicle 12. Note here that served mobile communication unit 40₁ is indicated in FIG. 1 as traveling with vehicle 12 (i.e., vehicle 40₁ is within dotted-line circle 19). It should be further noted that, while only one served mobile communication unit 40ₙ is indicated as traveling with vehicle 12, more than one served mobile communication unit 40ₙ may travel with vehicle 12. Server unit 42 may use the network based LBS infrastructure, represented in FIG. 1 as LBS unit 36, to determine the location of the identified served mobile communication unit or units 40ₙ. It is worthy of note here that no circuit changes or software changes need to be installed in the served mobile communication units 40ₙ.

Depending on the accuracy of the locations received, it may be necessary for server unit 42 to query the GPS location or cell location of the served mobile communication units 40ₙ that may have been associated with vehicle 12 several times for the location of vehicle 12 or the location of served mobile communication units 40ₙ to make sure which served mobile communication unit or units 40ₙ are actually traveling with vehicle 12. Those served mobile communication units 40ₙ that are determined to actually be in vehicle 12 (e.g., served mobile communication unit 40₁ in FIG. 1) may be referred to as traveling mobile communication devices.

Once it has been determined that a respective served mobile communication unit 40ₙ is most likely traveling with vehicle 12, server unit 42 may query HLR 34, SMSC/MMSC 38, or appropriate servers or gateways in mobile communication network 30 (not shown in detail in FIG. 1; known to one skilled in the art of mobile communication network design) to block selected services such as, by way of example and not by way of limitation, SMS originations, SMS terminations, voice originations, and voice terminations. A subscriber (not shown in FIG. 1) may determine which services are to be blocked to which traveling mobile communication device or devices by providing updates to provisioning unit 44.

Server unit 42 may periodically query vehicle 12 and traveling mobile communication devices to continue verifying that a respective served mobile communicating unit 40ₙ is still traveling with vehicle 12. If a respective traveling mobile communication device attempts to send an SMS communication, server unit 42 will re-verify that the respective mobile unit 40ₙ is traveling with vehicle 12 and thus remains a traveling mobile communication device. There may be other trigger events to re-query the location of a respective mobile unit such as, by way of example and not by way of limitation, vehicle speed and other vehicle operational parameters.

When apparatus 14 detects that vehicle 12 has stopped and has been turned off, apparatus 14 may notify server unit 42 of this changed status and the location of vehicle 12. Server unit 42 may then unblock the restricted services. A notification of the blocking and unblocking of services may be sent to the respective affected mobile communication unit 40ₙ using, by way of example and not by way of limitation, Short Message Service (SMS), Unstructured Supplementary Service Data (USSD) or another notification.

Apparatus 14 may be configured to monitor and communicate numerous operational parameters relating to vehicle 12 such as, by way of example and not by way of limitation, speed and direction of travel (by monitoring of GPS signals), acceleration, deceleration, g-forces around corners, and other parameters. This information can be sent to server unit 42 to provide information to apprise a subscriber regarding information such as, by way of example and not by way of limitation, vehicle driving habits, geofencing, stolen car recovery, speed around corners, acceleration, rate of acceleration, braking speed, driving habits, speed limit compliance, vehicle fault codes, oil change and service reminders and other information.

For purposes of this disclosure, a geofence is a virtual perimeter for a real-world geographic area. For example, a geofence may be dynamically generated such as, by way of example and not by way of limitation, as in a radius around a store or point location. Alternatively, a geofence may be a predefined set of boundaries such as, by way of example and not by way of limitation, a school attendance area, a neighborhood boundary or a customized area defining where a teenager or other vehicle operator may be permitted to drive.

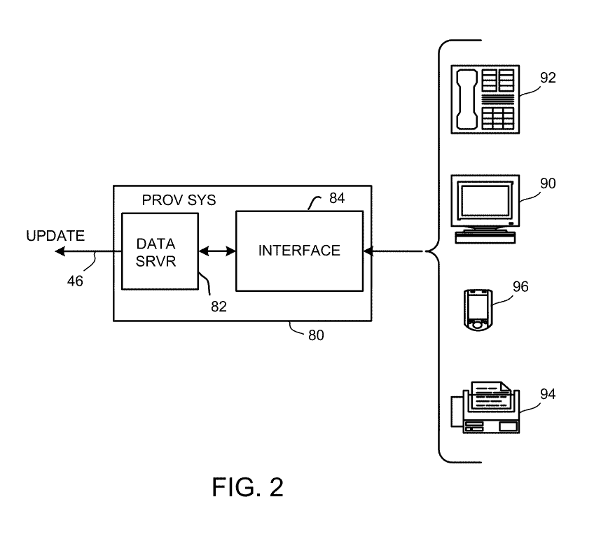

FIG. 2 is a schematic diagram illustrating various ways that the provisioning unit illustrated in FIG. 1 may be updated. In FIG. 2, a provisioning system 80 is configured for updating information in provisioning unit 44 (FIG. 1). Provisioning system 80 includes a data server unit 82 coupled with an interface unit 84.

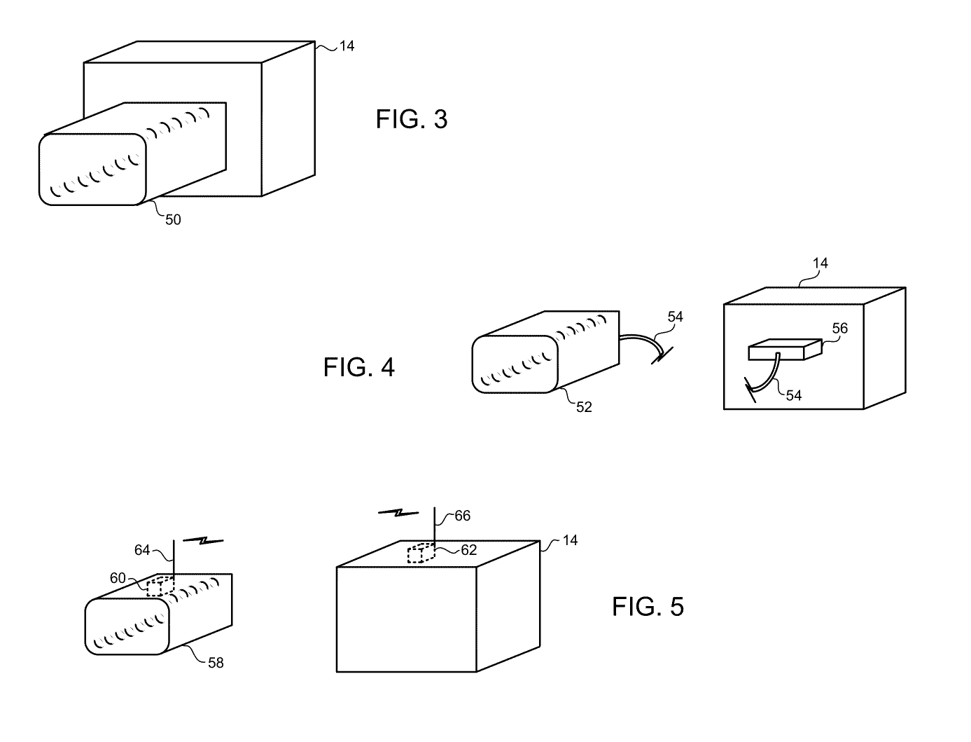

Provisioning system 80 is coupled with a communications or update port 46 associated with provisioning unit 44 (FIG. 1). Provisioning unit 44 may be updated based on preferences set up by a home or business subscriber and submitted to provisioning system 80 via interface unit 84 by any of various technologies known to those skilled in the art of telecommunication system design including, by way of example and not by way of limitation, a computer 90, a phone 92, a facsimile machine 94 and a PDA (Personal Digital Assistant) 96 or another communication device such as, by way of example and not by way of limitation, a smart phone (not shown in FIG. 3).

Updating via update port 46 may be effected using one or more various connection configurations such as, by way of example and not by way of limitation, a wireless connection, a cable connection and an infrared connection.

FIG. 3 is a schematic diagram illustrating a first representative embodiment for coupling the apparatus of the invention with an installed self diagnostic device. In FIG. 3, a connecting plug 50 is configured to couple with a self-diagnostic device 16 (FIG. 1). By way of example and not by way of limitation, self-diagnostic device 16 may present a coupling structure configured for receiving a plurality of inserted pins (e.g., a female coupler) and connecting plug 50 may be configured to present a plurality in a mating pattern (e.g., a male coupler) appropriate to permit receiving by self-diagnostic device 16. Details of the female and male couplers are not shown in FIG. 3 as such coupling structures are known to those skilled in the art of coupler design. Apparatus 14 may be coupled with connecting plug 50. In a preferred embodiment apparatus 14 may be substantially integrally formed with connecting plug 50 in a manner not providing easy separation of apparatus 14 from connecting plug 50.

FIG. 4 is a schematic diagram illustrating a second representative embodiment for coupling the apparatus of the invention with an installed self diagnostic device. In FIG. 4, a connecting plug 52 is configured to couple with a self-diagnostic device 16 (FIG. 1). By way of example and not by way of limitation, self-diagnostic device 16 may present a coupling structure configured for receiving a plurality of inserted pins (e.g., a female coupler) and connecting plug 52 may be configured to present a plurality in a mating pattern (e.g., a male coupler) appropriate to permit receiving by self-diagnostic device 16. Details of the female and male couplers are not shown in FIG. 4 as such coupling structures are known to those skilled in the art of coupler design. Apparatus 14 may be coupled with connecting plug 52 via a cable 54 (shown in a broken presentation to indicate that cable 54 may have any length). In a preferred embodiment apparatus 14 may connect with cable 54 via a standard coupling structure 56 such as, by way of illustration and not by way of imitation, a Universal Serial Bus (USB) connector. Standard coupling structure 56 may be embodied in another connector than a USB connector if desired so long as connecting plug 52, cable 54 and standard coupling structure 56 cooperate to operationally couple apparatus 14 with self-diagnostic device 16 (FIG. 1) appropriately to permit operation of a system 10 (FIG. 1) as described in this disclosure.

FIG. 5 is a schematic diagram illustrating a third representative embodiment for coupling the apparatus of the invention with an installed self diagnostic device. In FIG. 5, a connecting plug 58 is configured to couple with a self-diagnostic device 16 (FIG. 1). By way of example and not by way of limitation, self-diagnostic device 16 may present a coupling structure configured for receiving a plurality of inserted pins (e.g., a female coupler) and connecting plug 58 may be configured to present a plurality in a mating pattern (e.g., a male coupler) appropriate to permit receiving by self-diagnostic device 16. Details of the female and male couplers are not shown in FIG. 5 as such coupling structures are known to those skilled in the art of coupler design. Apparatus 14 may be coupled with connecting plug 58 via a wireless connection involving wireless communication units 60, 62 with associated antennas 64, 66. In a first preferred embodiment, wireless communication units 60, 62 are configured for effecting Unlicensed Mobile Access (UMA) communications. In a second preferred embodiment, communication units 60, 62 are configured for effecting wireless communications using Bluetooth technology (“Bluetooth” is a registered trademark of Bluetooth SIG, Inc.).

FIG. 6 is a flow diagram illustrating operation of the present invention. In FIG. 6, an operation 100 begins at a START locus 102. Apparatus 14 (reference numerals in this description of FIG. 6 refer to FIG. 1) cooperates with self-diagnostic device 16 to query whether vehicle 12 has been started and is moving, as indicated by a query block 104. If vehicle 12 has not been started and is not moving, apparatus 14 continues to cooperate with self-diagnostic device to monitor vehicle 12, as indicated by NO response line 106 returning operation 100 to a locus 147. If vehicle 12 has been started and is moving, apparatus 14 transmits this information, along with the GPS-based location coordinates (coordinates may be expressed in XY format, GPS coordinate format, or in another location-defining format) and other information relating vehicle 12 to server unit 42, as indicated by YES response line 108 and block 109.

Upon receipt of information indicating that vehicle 12 is a turned on and moving vehicle, server unit 42 will query the GPS-based location or cell location of the served mobile communication units 40ₙ that may have been associated with the vehicle (e.g., via update information provided to provisioning unit 44) to determine whether any served mobile communication units 40ₙ are in close proximity to the target vehicle 12, as indicated by blocks 110, 112, 114. Server unit 42 may use the network based LBS infrastructure, represented in FIG. 1 as LBS unit 36, to determine the location of the identified served mobile communication unit or units 40ₙ.

A query is posed whether any served mobile communication unit 40ₙ is sufficiently proximate with vehicle 12 to justify concluding that the proximate served mobile communication unit 40ₙ is in vehicle 12, as indicated by a query block 116. Other criteria may be applied in this analysis of whether a served mobile communication unit 40ₙ is n vehicle 12 such as, by way of example and not by way of limitation, comparing direction and speed of movement of a respective served mobile communication unit 40ₙ with direction and speed of movement of vehicle 12. If no served mobile communication unit 40ₙ is sufficiently proximate with vehicle 12 to justify concluding that the proximate served mobile communication unit 40ₙ is in vehicle 12, operation 100 proceeds from query block 116 via a NO response line 118 to a locus 119 and actions represented by blocks 110, 112, 114, 116 are performed again.

If a served mobile communication unit 40ₙ is sufficiently proximate with vehicle 12 to justify concluding that the proximate served mobile communication unit 40ₙ is in vehicle 12, operation 100 proceeds from query block 116 via a YES response line 120 and a query may be posed whether the respective served mobile communication unit (e.g., served mobile communication unit 40₁; FIG. 1) is located within a predetermined accuracy limit, as indicated by a query block 122. If the respective served mobile communication unit is not located within a predetermined accuracy limit, operation 100 proceeds from query block 122 via a NO response line 124 to locus 119 and actions represented by blocks 110, 112, 114, 116, 122 are performed again Depending on the accuracy of the locations received, it may be necessary for server unit 42 to query the GPS location or cell location of the served mobile communication units 40ₙ that may have been associated with vehicle 12 several times for the location of vehicle 12 or the location of served mobile communication units 40ₙ to make sure which served mobile communication unit or units 40ₙ are actually traveling with vehicle 12. If the respective served mobile communication unit 40ₙ is located within a predetermined accuracy limit, operation 100 proceeds from query block 122 via a YES response line 126. Those served mobile communication units 40ₙ that are determined to actually be in vehicle 12 (e.g., served mobile communication unit 40₁ in FIG. 1) may be referred to as traveling mobile communication devices.

Operation 100 continues with server unit 42 cooperating with one or more of HLR 34, SMSC/MMSC 38 and appropriate other servers or gateways in mobile communication network 30 to block selected services such as, by way of example and not by way of limitation, SMS originations, SMS terminations, voice originations, and voice terminations, as indicated by a block 128.

Server unit 42 may periodically query vehicle 12 and traveling mobile communication devices to continue verifying that a respective served-traveling mobile communicating unit 40ₙ is still traveling with vehicle 12. For example, a determination may be made whether an elapsed time Δt during which communications have been blocked is greater than a predetermined period T, as indicated by a query block 130. If communications have not been blocked for an elapsed time Δt greater than a predetermined period T, operation 100 may proceed from query block 130 via a NO response line 134 to a locus 145. By way of further example, server unit 42 may periodically query vehicle 12 and traveling mobile communication devices to continue verifying that a respective served mobile communicating unit 40ₙ is still traveling with vehicle 12 by determining whether other parameters remain within predetermined limits, as represented by a query block 132. Other parameters may include, by way of example and not by way of limitation, whether vehicle 12 is in PARK, whether vehicle 12 remains turned on but has not moved for a predetermined elapsed time and other parameters. If the other parameters remain within predetermined limits, operation 100 continues from query block 132 via a NO response line 136 to locus 145. Operation 100 may continue after returning to locus 145 via either of NO response lines 134, 136 and to again perform actions indicated by blocks 128, 130, 132.

If communications have been blocked for an elapsed time Δt greater than a predetermined period T or if the other parameters remain within predetermined limits, operation 100 may continue from query block 130 via a YES response line 138 or may continue from query block 132 via a YES response line 140 to query whether vehicle 12 is turned off and not moving, as indicated by a query block 142. If vehicle 12 is not turned off and is moving operation 100 may continue from query block 142 via a NO response line 144 to locus 145 and actions represented by blocks 128, 130, 132, 142 are performed again. If vehicle 12 is turned off and not moving operation 100 may continue from query block 142 via a YES response line 146 to locus 147 and actions represented by blocks 104, 110, 112, 114, 116, 122, 128, 130, 132, 142 are performed again.

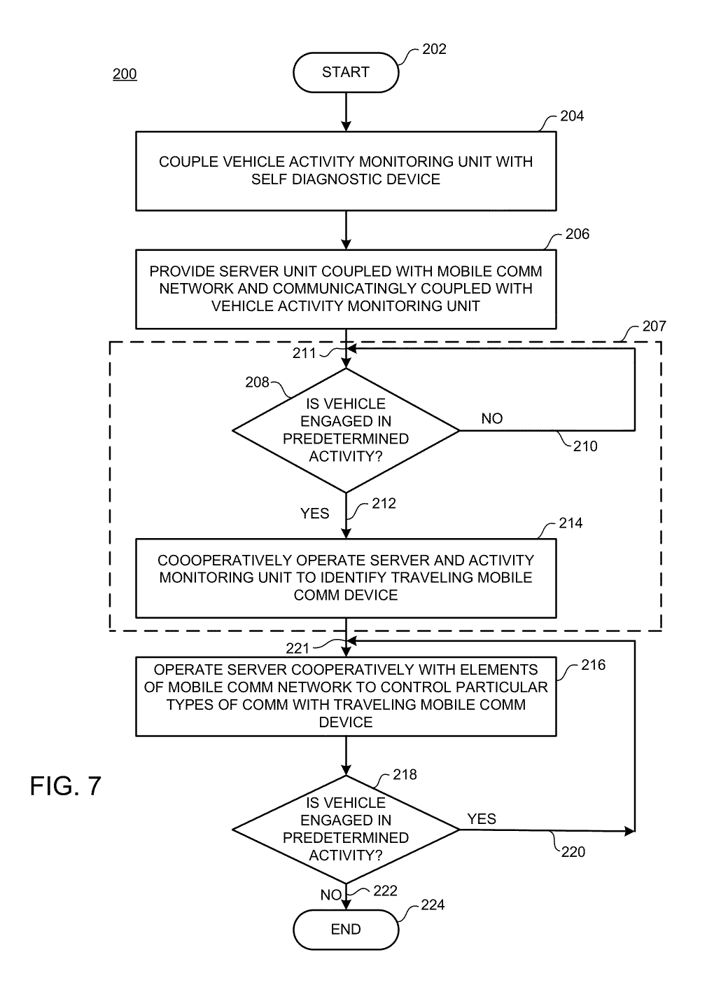

FIG. 7 is a flow diagram illustrating a first representation of the method of the present invention. In FIG. 7, a method 200 for controlling transmission of selected communications to at least one traveling mobile communication device carried by a vehicle having an installed self diagnostic device begins at a START locus 202. Method 200 continues with coupling a vehicle activity monitoring unit with the self diagnostic device, as represented by a block 204.

Method 200 continues with providing a server unit coupled with a mobile communication network and communicatingly coupled with the vehicle activity monitoring unit, as represented by a block 206. The mobile communication network includes a plurality of elements configured for effecting selected types of communications with served mobile communication units.

Method 200 continues with cooperatively operating the server unit with the activity monitoring unit to identify whether any of the served mobile communication units are the at least one traveling mobile communication device, as indicated by a dotted-line box 207. As indicated within dotted-line box 207, this identifying may be effected by posing a query whether a vehicle is engaged in a predetermined activity, as represented by a query block 208, and by cooperatively operating the server unit and activity monitoring unit to identify served mobile communicating units that are traveling with the vehicle, as indicated by a block 214. If no vehicle is engaged in a predetermined activity method 200 proceeds from query block 208 via a NO response line 210 to a locus 211. Method 200 continues from locus 211 to repeat the query represented by query block 208. If a vehicle is engaged in a predetermined activity method 200 proceeds from query block 208 via a YES response line 212 to identify served mobile communicating units that are traveling with the vehicle as traveling mobile communication devices, as indicated by a block 214.

Method 200 continues with operating the server unit cooperatively with particular elements of the plurality of elements of the mobile communication network to control particular types of communications of the selected types of communications with the at least one traveling mobile communication device, as represented by a block 216.

Method 200 may continue with posing a query whether a traveling mobile communication device is still engaged in the predetermined activity, as represented by a query block 218. If a traveling mobile communication device is still engaged in the predetermined activity, method 200 proceeds from query block 218 via a YES response line 220 to a locus 221. Method 200 thereafter proceeds from locus 221 to control communications with the traveling communication device as represented by block 216 and to pose the query posed by query block 218. If a traveling mobile communication device is not still engaged in the predetermined activity, method 200 proceeds from query block 218 via a NO response line 222 to terminate, as indicated by an END locus 224.

It is to be understood that, while the detailed drawings and specific examples given describe embodiments of the invention, they are for the purpose of illustration only, that the system and method of the invention are not limited to the precise details and conditions disclosed and that various changes may be made therein without departing from the spirit of the invention which is defined by the following claims:

1. A system for use with a vehicle having an installed self diagnostic device; the system controlling transmission of selected communications to at least one traveling mobile communication device carried by said vehicle; the system comprising:
(a) a vehicle activity monitoring unit; said vehicle activity monitoring unit being coupled with said self diagnostic device; and
(b) a server unit; said server unit being coupled for controlling communications with served mobile communication units communicatingly coupled with a mobile communication network; said mobile communication network including a plurality of elements configured for effecting selected types of communications with said served mobile communication units; said vehicle activity monitoring unit being communicatingly coupled with said server via said mobile communication network;
said server unit cooperating with said activity monitoring unit to identify which of said served mobile communication units are said at least one traveling mobile communication device; said server unit cooperating with particular elements of said plurality of elements of said mobile communication network to control particular types of communications of said selected types of communications with said at least one traveling mobile communication device when said vehicle activity monitoring unit indicates said vehicle is engaged in a predetermined activity.

2. The system for use with a vehicle having an installed self diagnostic device as recited in claim 1 wherein the system further comprises a data provisioning unit; said data provisioning unit being coupled with said server unit; said data provisioning unit identifies at least one of said predetermined activity and said particular types of communication to said server unit.

3. The system for use with a vehicle having an installed self diagnostic device as recited in claim 1 wherein said predetermined activity includes said vehicle being turned on and in motion.

4. The system for use with a vehicle having an installed self diagnostic device as recited in claim 1 wherein said vehicle activity monitoring unit monitors whether said vehicle is turned on and at least one of velocity of said vehicle; acceleration of said vehicle in up to three axes and location of the vehicle.

5. The system for use with a vehicle having an installed self diagnostic device as recited in claim 2 wherein said predetermined activity includes said vehicle being turned on and in motion.

6. The system for use with a vehicle having an installed self diagnostic device as recited in claim 2 wherein said vehicle activity monitoring unit monitors whether said vehicle is turned on and at least one of velocity of said vehicle, acceleration of said vehicle in up to three axes and location of said vehicle.

7. The system for use with a vehicle having an installed self diagnostic device as recited in claim 5 wherein said vehicle activity monitoring unit monitors whether said vehicle is turned on and at least one of velocity of said vehicle, acceleration of said vehicle in up to three axes and location of said vehicle.

8. An apparatus for use with a vehicle having an installed self diagnostic device; the apparatus comprising:
(a) a controller unit coupled with said self diagnostic device; said controller unit receiving information from said self diagnostic device regarding operating parameters of said vehicle; said controller unit substantially controlling operation of the apparatus; and
(b) a mobile communicating unit coupled with said controller unit; said mobile communicating unit being configured for communicating said operating parameters from the apparatus via a mobile communicating network.

9. An apparatus for use with a vehicle having an installed self diagnostic device as recited in claim 8 wherein said controller unit and said mobile communicating unit cooperate to effect said communicating said operating parameters when said vehicle is engaged in a predetermined activity.

10. An apparatus for use with a vehicle having an installed self diagnostic device as recited in claim 8 wherein said controller unit and said mobile communicating unit cooperate to effect said communicating in response to a received query when said vehicle being engaged in a predetermined activity.

11. An apparatus for use with a vehicle having an installed self diagnostic device as recited in claim 9 wherein said predetermined activity includes said vehicle being turned on and in motion.

12. An apparatus for use with a vehicle having an installed self diagnostic device as recited in claim 10 wherein said predetermined activity includes said vehicle being turned on and in motion.

13. An apparatus for use with a vehicle having an installed self diagnostic device as recited in claim 11 wherein said controller unit cooperates with said self diagnostic device to monitor whether said vehicle is turned on and at least one of velocity of said vehicle, acceleration of said vehicle in up to three axes and location of said vehicle.

14. An apparatus for use with a vehicle having an installed self diagnostic device as recited in claim 12 wherein said controller unit cooperates with said self diagnostic device to monitor whether said vehicle is turned on and at least one of velocity of said vehicle, acceleration of said vehicle in up to three axes and location of said vehicle.

15. A method for controlling transmission of selected communications to at least one traveling mobile communication device carried by a vehicle having an installed self diagnostic device; the method comprising:
(a) coupling a vehicle activity monitoring unit with said self diagnostic device;
(b) providing a server unit coupled with a mobile communication network and communicatingly coupled with said vehicle activity monitoring unit; said mobile communication network including a plurality of elements configured for effecting selected types of communications with served mobile communication units;
(c) cooperatively operating said server unit with said activity monitoring unit to identify which of said served mobile communication units are said at least one traveling mobile communication device;
(d) operating said server unit cooperatively with particular elements of said plurality of elements of said mobile communication network to control particular types of communications of said selected types of communications with said at least one traveling mobile communication device when said vehicle activity monitoring unit indicates said vehicle is engaged in a predetermined activity; and
(e) terminating the method when said vehicle activity monitoring unit indicates said vehicle is no longer engaged in a predetermined activity.

16. The method for controlling transmission of selected communications to at least one traveling mobile communication device carried by a vehicle having an installed self diagnostic device as recited in claim 15 wherein said predetermined activity includes said vehicle being turned on and in motion.

17. The method for controlling transmission of selected communications to at least one traveling mobile communication device carried by a vehicle having an installed self diagnostic device as recited in claim 15 wherein said vehicle activity monitoring unit monitors whether said vehicle is turned on and at least one of velocity of said vehicle; acceleration of said vehicle in up to three axes and location of the vehicle.

18. The method for controlling transmission of selected communications to at least one traveling mobile communication device carried by a vehicle having an installed self diagnostic device as recited in claim 16 wherein said vehicle activity monitoring unit monitors whether said vehicle is turned on and at least one of velocity of said vehicle; acceleration of said vehicle in up to three axes and location of the vehicle.

19. The method for controlling transmission of selected communications to at least one traveling mobile communication device carried by a vehicle having an installed self diagnostic device as recited in claim 17 wherein said predetermined activity is identified to said server unit by a user input to a database coupled with said server unit.

20. The method for controlling transmission of selected communications to at least one traveling mobile communication device carried by a vehicle having an installed self diagnostic device as recited in claim 18 wherein said predetermined activity is identified to said server unit by a user input to a database coupled with said server unit.
